(19) United States
(12) Patent Application Publication
(10) Pub. No.: US 2019/0148936 A1
(43) Pub. Date: May 16, 2019

(54) CIRCUIT FOR PREVENTING SURGE AND ELECTRONIC APPARATUS HAVING THE SAME

(71) Applicant: PEGATRON CORPORATION, TAIPEI CITY (TW)

(72) Inventors: Cheng-Chang Hsin, Taipei City (TW); Wei-Chun Tsao, Taipei City (TW); Han-Chiang Liao, Taipei City (TW)

(73) Assignee: PEGATRON CORPORATION, TAIPEI CITY (TW)

(21) Appl. No.: 16/181,014

(22) Filed: Nov. 5, 2018

(30) Foreign Application Priority Data
Nov. 16, 2017 (TW) 106139706

(51) Int. Cl. H02H 9/06; H02H 9/04

(52) U.S. Cl. CPC H02H 9/06; H02H 9/044

(57) ABSTRACT

A circuit for preventing surge and an electronic apparatus having the same are provided. The circuit for preventing surge is configured to serve as a surge discharging path of the signal path so as to protect the device body. The circuit for preventing surge includes first and second discharging circuits. The first discharging circuit is coupled between the signal path and a ground terminal. The first discharging circuit is turned on in response to a transient surge voltage on the signal path so as to discharge the transient surge voltage to be a first surge voltage. The second discharging circuit is connected to the first discharging circuit in parallel. When a voltage difference between the first surge voltage and a voltage of the ground terminal is greater than or equal to a threshold voltage, the second discharging circuit is turned on to discharge the first surge voltage.

### CROSS-REFERENCE TO RELATED APPLICATION

This application claims the priority benefit of Taiwan application serial no. 106139706, filed on Nov. 16, 2017. The entirety of the above-mentioned patent application is hereby incorporated by reference herein and made a part of this specification.

### BACKGROUND

### Technical Field

The application relates to a protection circuit. More particularly, the application relates to a circuit for preventing surge and an electronic apparatus having the same.

### Description of Related Art

A surge voltage may influence a product (e.g., a computer or a telephone and the like) itself through a power line or a ground path, and the extent and scope of such influence may vary according to the invasion path and the amount of energy. The surge voltage causes the greatest damage when the surge voltage is directly injected into the product. As long as an electronic apparatus is connected to an external signal cable, the electronic apparatus is likely to be damaged as affected by the transient surge voltage on the cable. Such surge voltage may be generated for many reasons, and lightening is one of the sources of such surge voltage. Hence, many types of technologies have been developed with an effort to prevent electronic apparatuses from being damaged by potential surge voltages.

For instance, a surge protection circuit may be installed on an input path of an electronic apparatus to discharge the surge voltage on the input path. Nevertheless, after an existing surge protection circuit discharges a surge high voltage, an excessively high residual voltage may still exist on the input path, and such excessively high residual voltage can still cause damages to the internal circuits of the electronic apparatus.

### SUMMARY

In view of the above, the application provides a circuit for preventing surge and an electronic apparatus having the same which can discharge a surge voltage on a signal path of the electronic apparatus and effectively lower a residual voltage on the signal path.

In an embodiment of the application, a circuit for preventing surge is configured to serve as a surge discharging path of a signal path. The circuit for preventing surge includes a first discharging circuit and a second discharging circuit. The first discharging circuit is coupled between the signal path and a ground terminal. The first discharging circuit is turned on in response to a transient surge voltage on the signal path so as to discharge the transient surge voltage to be a first surge voltage. The second discharging circuit is connected to the first discharging circuit in parallel. The second discharging circuit is turned on to discharge the first surge voltage when a voltage difference between the first surge voltage and a voltage of the ground terminal is greater than or equal to a threshold voltage.

In an embodiment of the application, an electronic apparatus includes a device body and a circuit for preventing surge. The device body is coupled to a signal path. The circuit for preventing surge is configured to serve as a surge discharging path of the signal path so as to protect the device body. The circuit for preventing surge provided by an embodiment of the application includes a first discharging circuit and a second discharging circuit. The first discharging circuit is coupled between the signal path and a ground terminal. The first discharging circuit is turned on in response to a transient surge voltage on the signal path so as to discharge the transient surge voltage to be a first surge voltage. The second discharging circuit is connected to the first discharging circuit in parallel. When a voltage difference between the first surge voltage and a voltage of the ground terminal is greater than or equal to a threshold voltage, the second discharging circuit is turned on to discharge the first surge voltage.

In an embodiment of the application, the first discharging circuit is a gas discharge tube.

In an embodiment of the application, the second discharging circuit is a varistor or a transient voltage suppression diode, and the threshold voltage is a breakdown voltage of the varistor or the transient voltage suppression diode.

In an embodiment of the application, the first discharging circuit is in a high impedance state after the transient surge voltage is discharged to be the first surge voltage.

In an embodiment of the application, the second discharging circuit is in a high impedance state before the transient surge voltage is discharged to be the first surge voltage.

To sum up, in the circuit for preventing surge and the electronic apparatus having the same provided by the embodiments of the application, the transient surge voltage on the signal path of the electronic apparatus can be discharged, and the residual voltage remained on the signal path can be effectively lowered. Therefore, the device body is prevented from being damaged due to that the residual voltage on the signal path is excessively high.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic circuit block diagram illustrating an electronic apparatus according to an embodiment of the application.

FIG. 2A is a schematic diagram illustrating a waveform of a first surge voltage according to an embodiment of the application.

FIG. 2B is a schematic diagram illustrating a waveform of a residual voltage on a signal path after the first surge voltage of FIG. 2A is discharged by a second discharging circuit.

FIG. 3A is a schematic diagram illustrating the waveform of the first surge voltage according to another embodiment of the application.

FIG. 3B is a schematic diagram illustrating the waveform of the residual voltage on the signal path after the first surge voltage of FIG. 3A is discharged by the second discharging circuit.

### DESCRIPTION OF THE EMBODIMENTS

In order to make the application more comprehensible, several embodiments are described below as examples of implementation of the application. In addition, wherever possible, identical or similar reference numerals stand for identical or similar elements/components in the drawings and the embodiments.

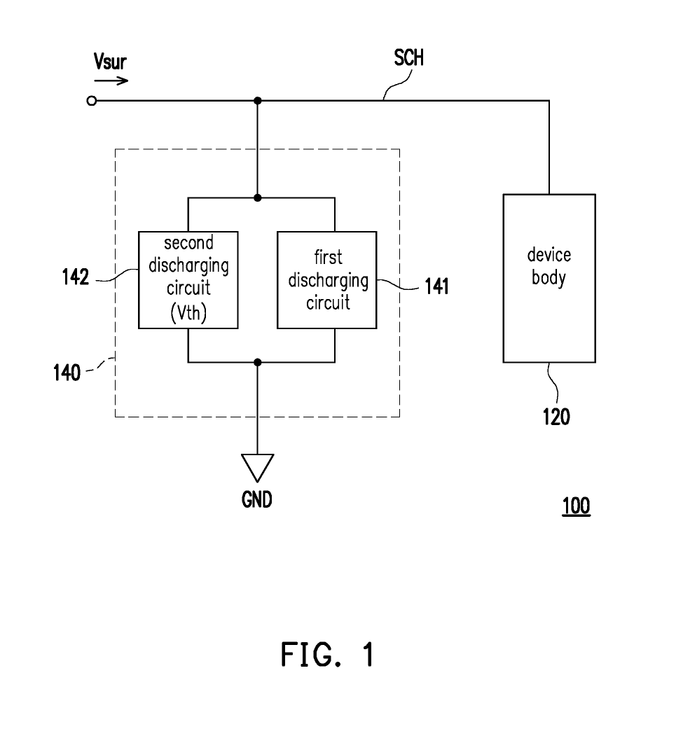

With reference to FIG. 1, FIG. 1 is a schematic circuit block diagram illustrating an electronic apparatus according to an embodiment of the application. In an embodiment of the application, an electronic apparatus 100 may be, for example, a personal computer, a power supplier, or a cable modem and the like, but the application is not limited thereto. The electronic apparatus 100 may include a device body 120 and a circuit for preventing surge 140. The device body 120 includes a circuit configured to perform a main function of the electronic apparatus 100. The device body 120 is coupled to a signal path SCH. In an embodiment of the application, the signal path SCH may be configured to perform power transmission or data transmission with an external apparatus, but the application is not limited thereto.

The circuit for preventing surge 140 is coupled to the signal path SCH and is configured to serve as a surge discharging path of the signal path SCH, so as to protect the device body 120. The circuit for preventing surge 140 may include a first discharging circuit 141 and a second discharging circuit 142, but the application is not limited thereto.

The first discharging circuit 141 is coupled between the signal path SCH and a ground terminal GND. The first discharging circuit 141 may be turned on in response to a transient surge voltage Vsur on the signal path SCH, so as to discharge the transient surge voltage Vsur on the signal path SCH to be a first surge voltage. In this way, the device body 120 is prevented from being damaged owing to a high voltage of the transient surge voltage Vsur, wherein the transient surge voltage Vsur may be, for example, a surge voltage of thousands of volts.

The second discharging circuit 142 is connected to the first discharging circuit 141 in parallel. When a voltage difference between the first surge voltage and a voltage of the ground terminal GND is greater than or equal to a threshold voltage Vth, the second discharging circuit 142 may be turned on to discharge the first surge voltage on the signal path SCH. In this way, a residual voltage on the signal path SCH may be effectively lowered so that the device body 120 is protected.

In an embodiment of the application, the first discharging circuit 141 may be, for example, a discharging circuit capable of carrying a greater current and being turned on with a relatively fast speed in response to a transient surge (i.e., the first discharging circuit 141 has a faster response speed), while the second discharging circuit 142 may be, for example, a discharging circuit capable of carrying a less current and being turned on with a relatively slow speed in response to the transient surge (i.e., the second discharging circuit 142 has a slower response speed). Further, when no transient surge voltage Vsur is presented on the signal path SCH, the first discharging circuit 141 and the second discharging circuit 142 are both in the high impedance state. When the transient surge voltage Vsur is presented on the signal path SCH, since the response speed of the first discharging circuit 141 is faster than the response speed of the second discharging circuit 142, the first discharging circuit 141 may be turned on earlier (i.e., in a low impedance state) so as to serve as a discharging path between the signal path SCH and the ground terminal GND and to discharge the transient surge voltage Vsur to be the first surge voltage. Before the transient surge voltage Vsur is discharged to be the first surge voltage, the second discharging circuit 142 remains in the high impedance state. In this way, the second discharging circuit 142 is prevented from being burned as the second discharging circuit 142 is unable to carry an excessively high discharging current. On the other hand, after the transient surge voltage Vsur is discharged to be the first surge voltage, the first discharging circuit 141 is switched to be in the high impedance state. At this time, if the voltage difference between the first surge voltage and the voltage of the ground terminal GND is greater than or equal to the threshold voltage Vth, the second discharging circuit 142 may be turned on (i.e., in the low impedance state) to serve as the discharging path between the signal path SCH and the ground terminal GND. Not until the voltage difference between the voltage on the signal path SCH and the voltage of the ground terminal GND is less than the threshold voltage Vth does the second discharging circuit 142 return to the high impedance state again. Through operations of the first discharging circuit 141 and the second discharging circuit 142, the residual voltage remained on the signal path SCH can be lowered.

In an embodiment of the application, the first discharging circuit 141 may be a gas discharge tube, but the application is not limited thereto.

In an embodiment of the application, the second discharging circuit 142 may be a varistor, and the threshold voltage Vth is a breakdown voltage of the varistor. Nevertheless, the application is not limited thereto.

In an embodiment of the application, the second discharging circuit 142 may be a transient voltage suppression diode (TVS diode), and the threshold voltage Vth is the breakdown voltage of the transient voltage suppression diode. Nevertheless, the application is not limited thereto.

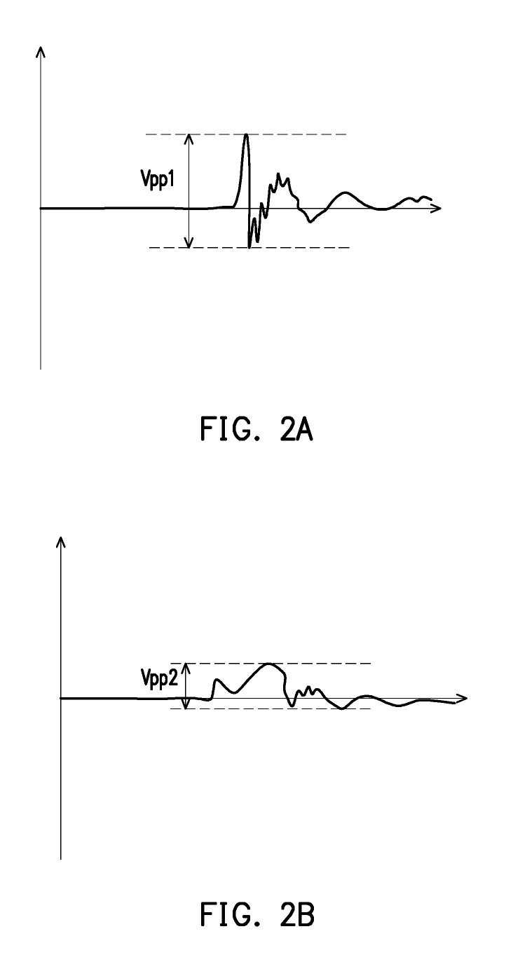

With reference to FIG. 1, FIG. 2A, and FIG. 2B together, FIG. 2A is a schematic diagram illustrating a waveform of a first surge voltage according to an embodiment of the application, and FIG. 2B is a schematic diagram illustrating a waveform of a residual voltage on the signal path SCH after the first surge voltage of FIG. 2A is discharged by the second discharging circuit 142. Among them, the horizontal axis represents time, the vertical axis represents the voltage, and the transient surge voltage Vsur applied on the signal path SCH is a positive surge voltage. It can be seen that a peak-to-peak voltage Vpp2 of the waveform of the residual voltage on the signal path SCH as shown in FIG. 2B is less than a peak-to-peak voltage Vpp1 of the waveform of the first surge voltage in FIG. 2A. Hence, the residual voltage remained on the signal path SCH may be effectively lowered by the second discharging circuit 142.

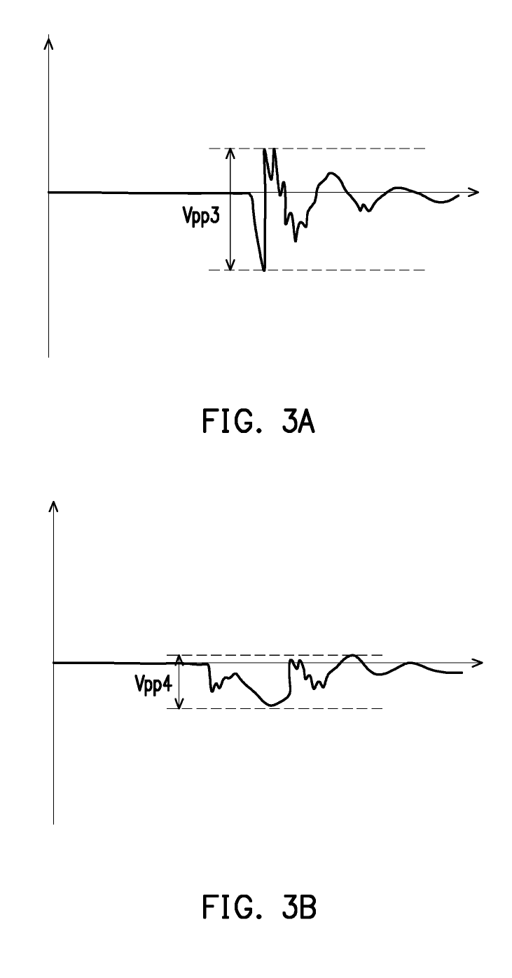

With reference to FIG. 1, FIG. 3A, and FIG. 3B together, FIG. 3A is a schematic diagram illustrating the waveform of the first surge voltage according to another embodiment of the application, and FIG. 3B is a schematic diagram illustrating the waveform of the residual voltage on the signal path SCH after the first surge voltage of FIG. 3A is discharged by the second discharging circuit 142. Among them, the horizontal axis represents time, the vertical axis represents the voltage, and the transient surge voltage Vsur applied on the signal path SCH is a negative surge voltage. It can be seen that a peak-to-peak voltage Vpp4 of the waveform of the residual voltage on the signal path SCH as shown in FIG. 3B is less than a peak-to-peak voltage Vpp3 of the waveform of the first surge voltage in FIG. 3A. Hence, the residual voltage remained on the signal path SCH may be effectively lowered by the second discharging circuit 142.

In view of the foregoing, in the circuit for preventing surge and the electronic apparatus having the same provided by the embodiments of the application, the transient surge voltage on the signal path of the electronic apparatus can be discharged, and the residual voltage remained on the signal path can be effectively lowered. Therefore, the device body is prevented from being damaged due to that the residual voltage on the signal path is excessively high.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A circuit for preventing surge, configured to serve as a surge discharging path of a signal path, the circuit for preventing surge comprising:
a first discharging circuit, coupled between the signal path and a ground terminal, wherein the first discharging circuit is turned on in response to a transient surge voltage on the signal path so as to discharge the transient surge voltage to be a first surge voltage; and
a second discharging circuit, connected to the first discharging circuit in parallel, the second discharging circuit being turned on to discharge the first surge voltage when a voltage difference between the first surge voltage and a voltage of the ground terminal is greater than or equal to a threshold voltage.

2. The circuit for preventing surge as claimed in claim 1, wherein the first discharging circuit is a gas discharge tube.

3. The circuit for preventing surge as claimed in claim 1, wherein the second discharging circuit is a varistor or a transient voltage suppression diode, and the threshold voltage is a breakdown voltage of the varistor or the transient voltage suppression diode.

4. The circuit for preventing surge as claimed in claim 1, wherein the first discharging circuit is in a high impedance state after the transient surge voltage is discharged to be the first surge voltage.

5. The circuit for preventing surge as claimed in claim 1, wherein the second discharging circuit is in a high impedance state before the transient surge voltage is discharged to be the first surge voltage.

6. An electronic apparatus, comprising:
a device body, coupled to a signal path; and
a circuit for preventing surge, configured to serve as a surge discharging path of the signal path so as to protect the device body, the circuit for preventing surge comprising:
a first discharging circuit, coupled between the signal path and a ground terminal, wherein the first discharging circuit is turned on in response to a transient surge voltage on the signal path so as to discharge the transient surge voltage to be a first surge voltage; and
a second discharging circuit, connected to the first discharging circuit in parallel, the second discharging circuit being turned on to discharge the first surge voltage when a voltage difference between the first surge voltage and a voltage of the ground terminal is greater than or equal to a threshold voltage.

7. The electronic apparatus as claimed in claim 6, wherein the first discharging circuit is a gas discharge tube.

8. The electronic apparatus as claimed in claim 6, wherein the second discharging circuit is a varistor or a transient voltage suppression diode, and the threshold voltage is a breakdown voltage of the varistor or the transient voltage suppression diode.

9. The electronic apparatus as claimed in claim 6, wherein the first discharging circuit is in a high impedance state after the transient surge voltage is discharged to be the first surge voltage.

10. The electronic apparatus as claimed in claim 6, wherein the second discharging circuit is in a high impedance state before the transient surge voltage is discharged to be the first surge voltage.
